(19) United States
(12) Patent Application Publication
(10) Pub. No.: US 2002/0127499 A1
(43) Pub. Date: Sep. 12, 2002

(54) Mold, method for fabricating mold and pattern formation method

(76) Inventors: Masayuki Endo, Izumi-shi (JP); Masaru Sasago, Hirakata-shi (JP); Norihisa Mino, Nara-shi (JP); Kazufumi Ogawa, Nara-shi (JP); Yoshihiko Hirai, Osaka-shi (JP)

Correspondence Address: NIXON PEABODY, LLP, 8180 GREENSBORO DRIVE, SUITE 800, MCLEAN, VA, 22102, US

(21) Appl. No.: 10/059,225

(22) Filed: Jan. 31, 2002

(30) Foreign Application Priority Data
Mar. 8, 2001 (JP) 2001-065062

(51) Int. Cl. G03C 5/00

(52) U.S. Cl. 430/327

(57) ABSTRACT

A mold body included in a mold of the invention has a pressing face. A surface treated layer including a compound represented by a general formula, CF₃(CZ)ₙSiXₐY₃₋ₐ, wherein n is an integer of 8 or more; a is 1, 2 or 3; Z are the same or different and selected from the group consisting of a hydrogen atom, a halogen atom, a substituted or non-substituted saturated or unsaturated alkyl group and a substituted or non-substituted aromatic group; X is a halogen atom; and Y is a hydrogen atom or a saturated alkyl group, is formed at least on the pressing face of the mold body.

### BACKGROUND OF THE INVENTION

The present invention relates to a mold for use in an imprint method, a method for fabricating the mold and a pattern formation method using the mold.

In accordance with improvement in the degree of integration of semiconductor integrated circuits, there are increasing demands for refinement of a resist pattern formed by lithography.

Although a conventional resist pattern is formed by the lithography, it has become very difficult to form a fine resist pattern of 100 nm or less by the lithography because of, for example, a limit on reducing the wavelength of exposing light.

Also, the lithography using EB (electron beams) as the exposing light has a merit in the resolution but is difficult to apply to the mass production because of low throughput.

Therefore, a method for forming a fine pattern with high productivity by using an imprint method has been proposed (for example, S. Y. Chou et al., Appl. Phys. Lett., vol. 67, p. 3114 (1995)).

In this imprint method, a mold having irregularities corresponding to a mirror image of a pattern to be transferred is pressed against a resist film formed on a substrate, so as to form a pattern of the resist film.

A pattern formation method using the imprint method will now be described as a first conventional example with reference to FIGS. 7A through 7C, 8A and 8B.

First, as shown in FIG. 7A, after forming, for example, a silicon oxide film on a mold substrate 1, the silicon oxide film is subjected to general lithography. Thus, a reverse pattern 2 corresponding to a mirror image of a pattern to be transferred (namely, an interconnect pattern) that is obtained by reversing the pattern to be transferred is formed from the silicon oxide film. In this manner, a mold composed of the mold substrate 1 and the reverse pattern 2 is obtained.

Next, as shown in FIG. 7B, an organic film (for example, a resist film) 4 of, for example, poly(methyl methacrylate) (PMMA) with a thickness of 0.3 μm is formed on a semiconductor substrate 3.

Then, as shown in FIG. 7C, the semiconductor substrate 3 having the organic film 4 is heated to, for example, 170° C. so as to soften the organic film 4, and then, the mold of FIG. 7A is brought close to the softened organic film 4.

Subsequently, as shown in FIG. 8A, the mold is pressed against the softened organic film 4 at a pressure of approximately 140 atm., so as to transfer the reverse pattern 2 of the mold onto the organic film 4. In this manner, an organic film pattern (for example, a resist pattern) 4A can be formed from the organic film 4.

Next, with the mold pressed against the organic film 4, the temperature of the semiconductor substrate 3 is lowered to, for example, 105° C. so as to cure the organic film pattern 4A.

Then, as shown in FIG. 8B, the mold is moved away from the organic film pattern 4A. Thus, the fine organic film pattern 4A of, for example, 0.10 μm is formed on the semiconductor substrate 3.

However, in moving the mold away from the organic film pattern 4A, the organic film pattern 4A is partly adhered to the inside of the reverse pattern 2 of the mold. Therefore, the organic film pattern 4A is formed in a defective shape as shown in FIG. 8B. When the shape of the organic film pattern 4A is defective, an interconnect pattern formed by using the organic film pattern 4A as a mask is also in a defective shape, resulting in disadvantageously lowering the yield of semiconductor devices.

Accordingly, a technique to move a mold smoothly away from an organic film pattern by treating the surface of the mold with a solution including fluorine has been proposed (M. Colburn et al., SPIE 25th Intl. Symp. Microlithography: Emerging Lithographic Technologies IV, Santa Clara, Calif., 2000, p. 453).

A method for forming a pattern by using a mold whose surface is treated with a solution including fluorine will now be described as a second conventional example with reference to FIGS. 9A through 9C and 10A through 10C.

First, in the same manner as in the first conventional example, a reverse pattern 2 is formed on a mold substrate 1 so as to obtain a mold composed of the mold substrate 1 and the reverse pattern 2 as shown in FIG. 9A. Then, the mold is immersed in a 0.2 wt % CF₃(CF₂)₅(CH₂)₂SiCl₃ solution (solvent: HFE7100 (manufactured by Minnesota Mining and Manufacturing Co.)) for 10 minutes. Thereafter, the resultant mold is rinsed with HFE7100 for 15 minutes. Thus, a surface treated layer 5 including fluorine is formed on the mold as shown in FIG. 9B.

Next, in the same manner as in the first conventional example, an organic film (for example, a resist film) 4 of, for example, poly(methyl methacrylate) (PMMA) with a thickness of 0.3 μm is formed on a semiconductor substrate 3 as shown in FIG. 9C. Then, as shown in FIG. 10A, the semiconductor substrate 3 is heated to, for example, 170° C. so as to soften the organic film 4, and the mold of FIG. 9B is brought close to the softened organic film 4.

Subsequently, as shown in FIG. 10B, the mold is pressed against the softened organic film 4 at a pressure of approximately 140 atm., so as to transfer the reverse pattern 2 of the mold onto the organic film 4. In this manner, an organic film pattern (for example, a resist pattern) 4B can be formed from the organic film 4.

Next, with the mold pressed against the organic film 4, the temperature of the semiconductor substrate 3 is lowered to, for example, 105° C. so as to cure the organic film pattern 4B.

Then, as shown in FIG. 10C, the mold is moved away from the organic film pattern 4B. Thus, the fine organic film pattern 4B of, for example, 0.10 μm is formed on the semiconductor substrate 3.

In the second conventional example, since the mold on which the surface treated layer 5 including fluorine is formed is used for forming the organic film pattern 4B, the shape of the organic film pattern 4B is better than that of the organic film pattern 4A obtained in the first conventional example.

However, in moving the mold away from the organic film pattern 4B, the organic film pattern 4B is still partly adhered to the inside of the reverse pattern 2 of the mold. Therefore, the shape of the organic film pattern 4B cannot be improved to a satisfactory level as shown in FIG. 10C. Accordingly, the shape of an interconnect pattern formed by using the organic film pattern 4B as a mask cannot be satisfactory, and hence, the yield of semiconductor devices cannot be sufficiently improved.

### SUMMARY OF THE INVENTION

In consideration of the conventional problems, an object of the invention is improving the shape of an organic film pattern by substantially preventing the organic film pattern from adhering to a reverse pattern in moving a mold away from the organic film pattern.

In order to achieve the object, the mold of this invention comprises a mold body having a pressing face; and a surface treated layer formed on at least the pressing face of the mold body and including a compound represented by a general formula, CF₃(CZ)ₙSiXₐY₃₋ₐ, wherein n is an integer of 8 or more; a is 1, 2 or 3; Z are the same or different and selected from the group consisting of a hydrogen atom, a halogen atom, a substituted or non-substituted saturated or unsaturated alkyl group and a substituted or non-substituted aromatic group; X is a halogen atom; and Y is a hydrogen atom or a saturated alkyl group.

In the mold of this invention, since n is an integer of 8 or more in the general formula, CF₃(CZ)ₙSiXₐY₃₋ₐ, representing the compound included in the surface treated layer, the molecular chains of monomolecular films of CF₃(CZ)ₙSi are long, and hence, the interaction between the adjacent molecular chains is so large that the monomolecular films can align without falling down. Therefore, the surface treated layer is covered with CF₃ groups, so that the hydrophobic property of the surface treated layer can be improved and that the resistance of the surface treated layer exhibited in pressing the pressing face of the mold body against the organic film can be improved.

Accordingly, the organic film pattern is minimally adhered to the pressing face in moving the mold away from the organic film pattern, so that the organic film pattern can be formed in a good shape.

In the mold of this invention, at least one of Z is preferably a fluorine atom in the general formula.

Thus, the hydrophobic property of the surface treated layer can be further improved, and hence, the organic film pattern is less adhered to the pressing face in moving the mold away from the organic film pattern.

In the mold of this invention, a projection or recess for forming a pattern is preferably formed on the pressing face of the mold body.

The method for fabricating a mold of this invention comprises the steps of preparing a mold body having a pressing face; and forming, at least on the pressing face of the mold body, a surface treated layer including a compound represented by a general formula, CF₃(CZ)ₙSiXₐY₃₋ₐ, by bringing the compound into contact with the pressing face, wherein n is an integer of 8 or more; a is 1, 2 or 3; Z are the same or different and selected from the group consisting of a hydrogen atom, a halogen atom, a substituted or non-substituted saturated or unsaturated alkyl group and a substituted or non-substituted aromatic group; X is a halogen atom; and Y is a hydrogen atom or a saturated alkyl group.

In the method for fabricating a mold of this invention, since n is an integer of 8 or more in the general formula, CF₃(CZ)ₙSiXₐY₃₋ₐ, representing the compound included in the surface treated layer, the molecular chains of monomolecular films of CF₃(CZ)ₙSi are long, and hence, the interaction between the adjacent molecular chains is so large that the monomolecular films can align without falling down. Therefore, the surface treated layer is covered with CF₃ groups, so that the hydrophobic property of the surface treated layer can be improved and that the resistance of the surface treated layer exhibited in pressing the pressing face of the mold body against the organic film can be improved.

Accordingly, the organic film pattern is minimally adhered to the pressing face in moving the mold away from the organic film pattern, so that the organic film pattern can be formed in a good shape.

The method for fabricating a mold of this invention preferably further comprises, after the step of forming a surface treated layer, a step of removing an excessive portion of the compound adhered to the mold body in an atmosphere including substantially no moisture.

Thus, the effect to remove an excessive portion of the compound can be improved. Specifically, if an excessive portion of the compound is removed in an atmosphere including moisture, the excessive portion of the compound reacts with water, which makes it difficult to remove the excessive portion. In this case, a water vapor concentration in the atmosphere is preferably 0.0076 kg/m³ or less. An excessive portion of the compound should be removed because the hydrophobic property of the surface treated layer may be spoiled.

In the method for fabricating a mold of this invention, at least one of Z is preferably a fluorine atom in the general formula.

Thus, the hydrophobic property of the surface treated layer can be further improved, and hence, the organic film pattern can be less adhered to the pressing face in moving the mold away from the organic film pattern.

In the method for fabricating a mold of this invention, the compound is preferably brought into contact with the pressing face by allowing a solution including the compound to come in contact with the pressing face.

Thus, the surface treated layer can be formed on the pressing face of the mold body easily and definitely.

In this case, the solution preferably includes substantially no water.

This is because if the solution includes water, the compound represented by CF₃(CZ)ₙSiXₐY₃₋ₐ reacts with the water included in the solution so that a good surface treated layer cannot be formed.

In the method for fabricating a mold of this invention, the solution is preferably allowed to come in contact with the pressing face by immersing, spin coating or rubbing.

In the method for fabricating a mold of this invention, the step of forming a surface treated layer is preferably carried out in an atmosphere including substantially no moisture.

The reason is as follows: Since the compound represented by CF₃(CZ)ₙSiXₐY₃₋ₐ has a property to react with water, if a surface treated layer is formed in an atmosphere including moisture, the compound represented by CF₃(CZ)ₙSiXₐY₃₋ₐ reacts with the moisture, so that a good surface treated layer cannot be formed.

In this case, a water vapor concentration in the atmosphere is preferably 0.0076 kg/m³ or less.

Thus, the compound represented by CF₃(CZ)ₙSiXₐY₃₋ₐ minimally reacts with water, so that a good surface treated layer can be formed.

In the method for fabricating a mold of this invention, the step of preparing a mold body preferably includes a sub-step of forming a projection or recess for forming a pattern on the pressing face.

The first pattern formation method of this invention comprises the steps of forming an organic film on a substrate; transferring a projection or recess for forming a pattern provided on a pressing face of a mold onto the organic film by pressing, against the organic film, the mold that has, at least on the pressing face, a surface treated layer including a compound represented by a general formula, CF₃(CZ)ₙSiXₐY₃₋ₐ, wherein n is an integer of 8 or more, a is 1, 2 or 3, Z are the same or different and selected from the group consisting of a hydrogen atom, a halogen atom, a substituted or non-substituted saturated or unsaturated alkyl group and a substituted or non-substituted aromatic group, X is a halogen atom, and Y is a hydrogen atom or a saturated alkyl group; and moving the mold away from the organic film.

In the first pattern formation method of this invention, the surface of the surface treated layer formed on the pressing face of the mold is covered with CF₃ groups. Therefore, the hydrophobic property of the surface treated layer can be improved, and the resistance exhibited by the surface treated layer in pressing the pressing face of the mold against the organic film can be improved.

Accordingly, the organic film pattern is minimally adhered to the pressing face in moving the mold away from the organic film pattern, so that the organic film pattern can be formed in a good shape.

The second pattern formation method of this invention comprises the steps of forming an organic film on a substrate with a light transmitting property; transferring a projection or recess for forming a pattern provided on a pressing face of a mold onto the organic film by pressing, against the organic film, the mold that has, at least on the pressing face, a surface treated layer including a compound represented by a general formula, CF₃(CZ)ₙSiXₐY₃₋ₐ, wherein n is an integer of 8 or more, a is 1, 2 or 3, Z are the same or different and selected from the group consisting of a hydrogen atom, a halogen atom, a substituted or non-substituted saturated or unsaturated alkyl group and a substituted or non-substituted aromatic group, X is a halogen atom, and Y is a hydrogen atom or a saturated alkyl group; curing the organic film by irradiating the organic film with light through the substrate; and moving the mold away from the organic film.

In the second pattern formation method of this invention, since the surface of the surface treated layer formed on the pressing face of the mold is covered with CF₃ groups, the hydrophobic property of the surface treated layer can be improved and the resistance exhibited by the surface treated layer in pressing the pressing face of the mold against the organic film can be improved.

Furthermore, since the organic film is cured by irradiating the organic film through the substrate, the organic film can be made from a material with a softening property. Therefore, the projection or recess can be easily transferred onto the organic film by pressing the pressing face of the mold against the organic film.

In the first or second pattern formation method of this invention, at least one of Z is preferably a fluorine atom in the general formula.

Thus, the hydrophobic property of the surface treated layer can be further improved, and hence, the organic film pattern is less adhered to the pressing face in moving the mold away from the organic film pattern.

In the second pattern formation method of this invention, the light is preferably UV or deep Uv.

### BRIEF DESCRIPTION OF THE DRAWINGS

FIGS. 1A, 1B and 1C are cross-sectional views for showing a mold and procedures in a method for fabricating the mold and a pattern formation method according to Embodiment 1 of the invention;

FIGS. 2A, 2B and 2C are cross-sectional views for showing the mold and other procedures in the method for fabricating the mold and the pattern formation method of Embodiment 1;

FIGS. 3A, 3B, 3C and 3D are cross-sectional views for showing a mold and procedures in a method for fabricating the mold and a pattern formation method according to Embodiment 2 of the invention;

FIGS. 4A, 4B, 4C and 4D are cross-sectional views for showing a mold and procedures in a method for fabricating the mold and a pattern formation method according to Embodiment 3 of the invention;

FIGS. 5A, 5B and 5C are cross-sectional views for showing the mold and other procedures in the method for fabricating the mold and the pattern formation method of Embodiment 3;

FIG. 6A is a conceptual diagram for showing the structure of a surface treated layer obtained when n is 8 in a general formula, CF₃(CZ)ₙSiXₐY₃₋ₐ and

FIG. 6B is a conceptual diagram for showing the structure of a surface treated layer obtained when n is 7 in the general formula, CF₃(CZ)ₙSiXₐY₃₋ₐ;

FIGS. 7A, 7B and 7C are cross-sectional views for showing procedures in a pattern formation method according to a first conventional example;

FIGS. 8A and 8B are cross-sectional views for showing other procedures in the pattern formation method of the first conventional example;

FIGS. 9A, 9B and 9C are cross-sectional views for showing procedures in a pattern formation method according to a second conventional example; and

FIGS. 10A, 10B and 10C are cross-sectional views for showing other procedures in the pattern formation method of the second conventional example.

### DETAILED DESCRIPTION OF THE INVENTION

Embodiment 1

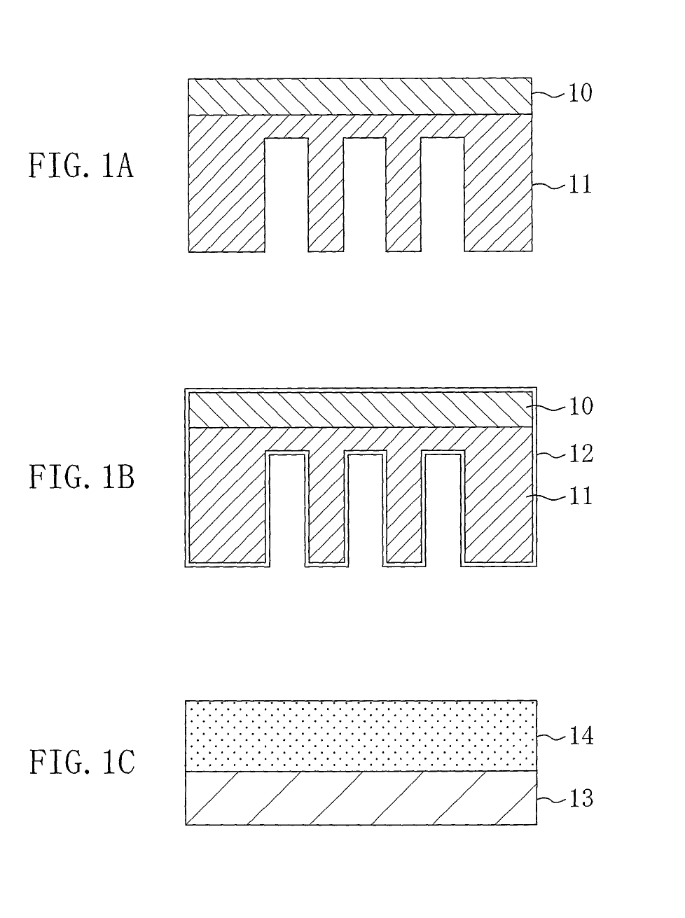

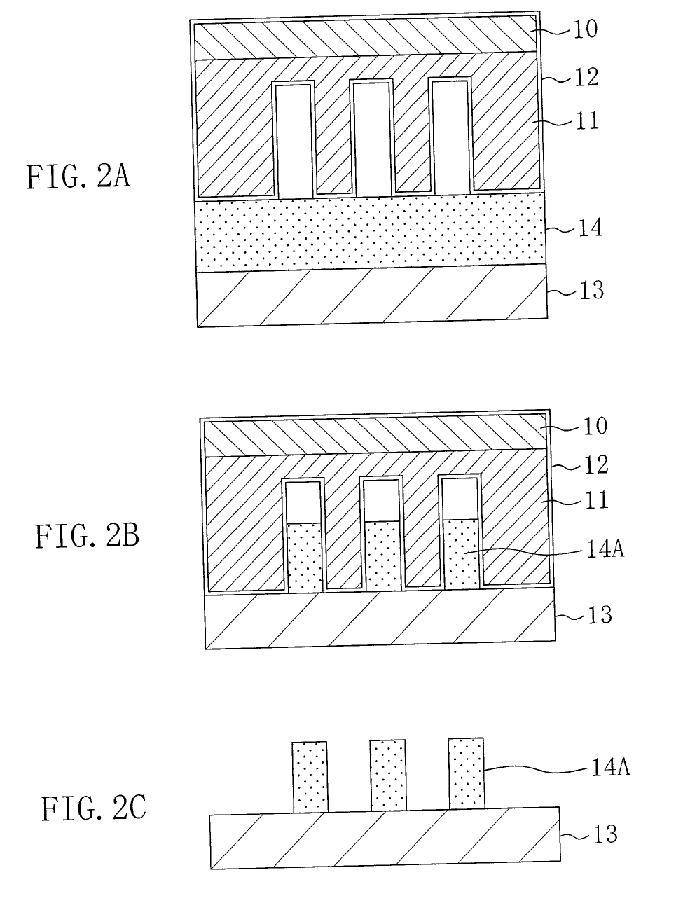

Embodiment 1 of the invention will now be described with reference to FIGS. 1A through 1C and 2A through 2C.

First, as shown in FIG. 1A, a reverse pattern 11 corresponding to a mirror image of a pattern to be transferred (for example, an interconnect pattern), which is obtained by reversing the pattern to be transferred, is formed from a silicon oxide film on a mold substrate 10. Thus, a mold body composed of the mold substrate 10 and the reverse pattern 11 can be obtained. The reverse pattern 11 may be formed from a silicon film or a silicon carbide film instead of the silicon oxide film.

Next, the mold is immersed in a 0.2 wt % CF₃(CF₂)₇(CH₂)₂SiCl₃ solution (solvent: a mixture of hexadecane and chloroform in a weight ratio of 4:1) for 10 minutes in a dry atmosphere (including substantially no moisture), such as an atmosphere with a water vapor concentration of 0.006 kg/m³. Thus, a surface treated layer 12 is formed on the mold body composed of the mold substrate 10 and the reverse pattern 11 as shown in FIG. 1B.

Then, the mold body bearing the surface treated layer 12 is rinsed with a mixture of hexadecane and chloroform (in a weight ratio of 4:1) for 15 minutes in a dry atmosphere (including substantially no moisture), such as an atmosphere with a water vapor concentration of 0.006 kg/m³, so as to remove an excessive portion of the compound (CF₃(CF₂)₇(CH₂)₂SiCl₃) adhered to the surface treated layer 12.

Next, as shown in FIG. 1C, an organic film (for example, a resist film) 14 of, for example, poly(methyl methacrylate) (PMMA) with a thickness of 0.3 μm is formed on a semiconductor substrate 13. Thereafter, as shown in FIG. 2A, the semiconductor substrate 13 having the organic film 14 is heated to, for example, 170° C. so as to soften the organic film 14, and then, the mold of FIG. 1B is brought close to the softened organic film 14.

Subsequently, as shown in FIG. 2B, a pressing face of the reverse pattern 12 is pressed against the softened organic film 14 at a pressure of approximately 140 atm., so as to transfer the reverse pattern 12 onto the organic film 14. In this manner, an organic film pattern (for example, a resist pattern) 14A is formed from the organic film 14.

Then, with the mold pressed against the organic film 14, the temperature of the semiconductor substrate 13 is lowered to, for example, 105° C. so as to cure the organic film pattern 14A.

Thereafter, as shown in FIG. 2C, the mold is moved away from the organic film pattern 14A. Thus, the fine organic film pattern 14A of, for example, 0.10 μm is formed on the semiconductor substrate 13.

In Embodiment 1, since the organic film pattern 14A is formed by pressing, against the organic film 14, the reverse pattern 11 of the mold bearing the surface treated layer 12 including CF₃(CF₂)₇(CH₂)₂SiCl₃. Therefore, the reverse pattern 11 can be smoothly moved away from the organic film pattern 14A and the organic film pattern 14A is minimally adhered to the recess of the reverse pattern 11. Accordingly, the organic film pattern 14A can be formed in a good shape as shown in FIG. 2C.

Embodiment 2

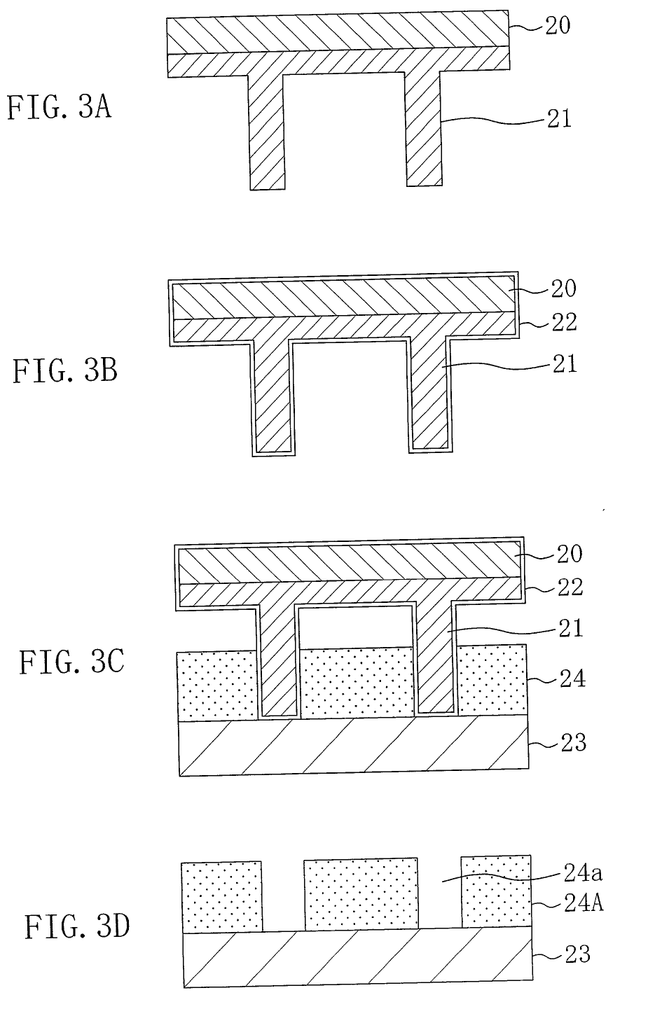

Embodiment 2 of the invention will now be described with reference to FIGS. 3A through 3D.

First, as shown in FIG. 3A, a reverse pattern 21 corresponding to a mirror image of a pattern to be transferred (for example, a contact hole), which is obtained by reversing the pattern to be transferred, is formed from a silicon oxide film on a mold substrate 20. Thus, a mold body composed of the mold substrate 20 and the reverse pattern 21 is obtained. The reverse pattern 21 may be formed from a silicon film or a silicon carbide film instead of the silicon oxide film.

Next, the mold body composed of the mold substrate 20 and the reverse pattern 21 is immersed in a 0.3 wt % CF₃(CH₂)₉Si(CH₃)Cl₂ solution (solvent: a mixture of hexadecane and chloroform in a weight ratio of 4:1) for 10 minutes in a dry atmosphere (including substantially no moisture), such as an atmosphere with a water vapor concentration of 0.005 kg/m³. Thus, a surface treated layer 22 is formed on the mold body composed of the mold substrate 20 and the reverse pattern 21 as shown in FIG. 3B.

Then, the mold bearing the surface treated layer 22 is rinsed with a mixture of hexadecane and chloroform (in a weight ratio of 4:1) for 5 minutes in a dry atmosphere (including substantially no moisture) such as an atmosphere with a water vapor concentration of 0.005 kg/m³. Thereafter, an excessive portion of the compound (CF₃(CH₂)₉Si(CH₃)Cl₂) adhered to the surface treated layer 22 is removed by conducting a heat treatment at 100° C. for 120 seconds.

Subsequently, as shown in FIG. 3C, the reverse pattern 21 of the mold is pressed against an organic film 24 formed on a semiconductor substrate 23, so as to transfer the reverse pattern 21 onto the organic film 24. Then, the mold is moved away from the organic film 24. Thus, an organic film pattern 24A having a contact hole opening 24a is obtained as shown in FIG. 3D.

In Embodiment 2, since the organic film pattern 24A is formed by pressing, against the organic film 24, the reverse pattern 21 of the mold bearing the surface treated layer 22 including CF₃(CH₂)₉Si(CH₃)Cl₂. Therefore, the reverse pattern 21 can be smoothly moved away from the organic film pattern 24A and the organic film pattern 24A is minimally adhered to the projection of the reverse pattern 21. Accordingly, the organic film pattern 24A can be formed in a good shape as shown in FIG. 3D.

Embodiment 3

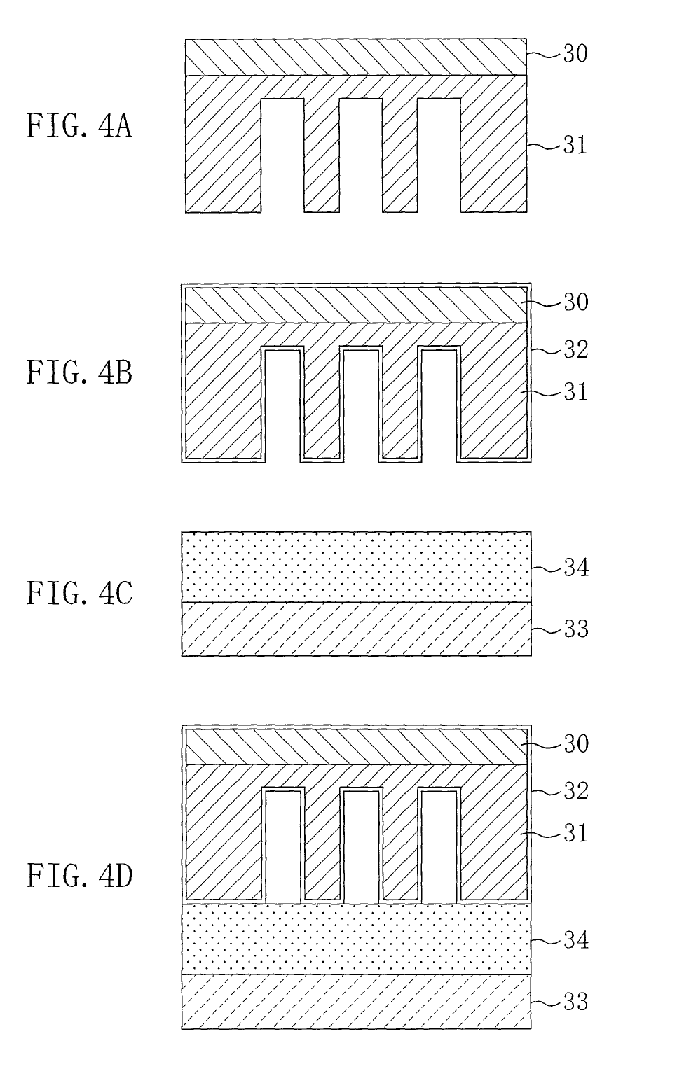

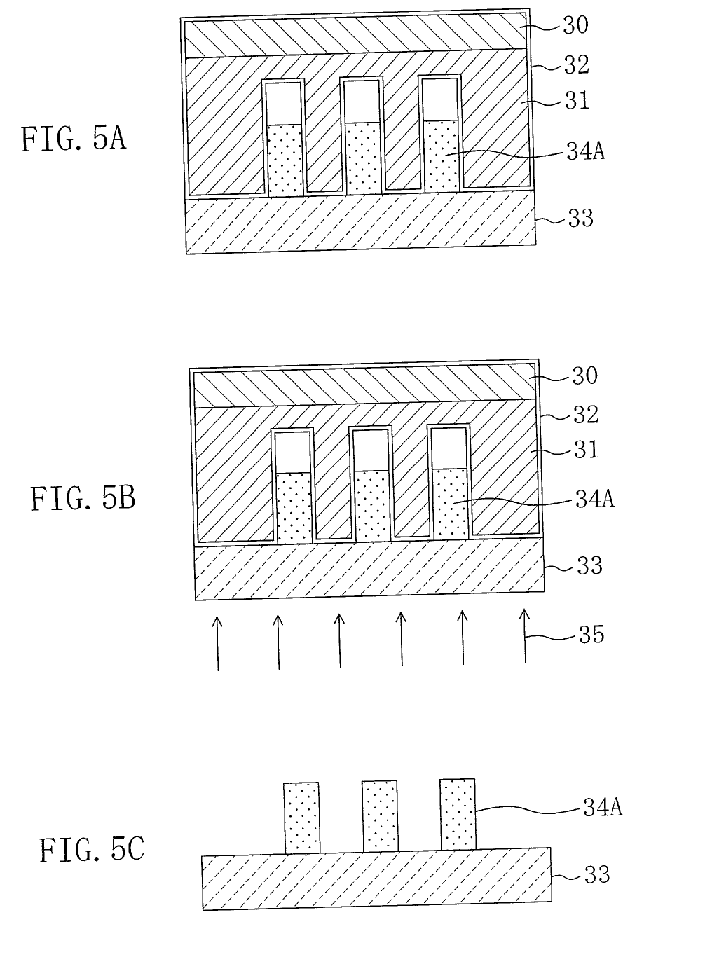

Embodiment 3 of the invention will now be described with reference to FIGS. 4A through 4D and 5A through 5C.

First, as shown in FIG. 4A, a reverse pattern 31 corresponding to a mirror image of a pattern to be transferred (for example, an interconnect groove), which is obtained by reversing the pattern to be transferred, is formed from a silicon oxide film on a mold substrate 30. Thus, a mold body composed of the mold substrate 30 and the reverse pattern 31 is obtained. The reverse pattern 31 may be formed from a silicon film or a silicon carbide film instead of the silicon oxide film.

Next, the mold body composed of the mold substrate 30 and the reverse pattern 31 is immersed in a 0.2 wt % CF₃(CF₂)₈SiCl₃ solution (solvent: a mixture of hexadecane and chloroform in a weight ratio of 4:1) for 5 minutes in a dry atmosphere (including substantially no moisture), such as an atmosphere with a water vapor concentration of 0.006 kg/m³. Thus, a surface treated layer 32 is formed on the mold body composed of the mold substrate 30 and the reverse pattern 31 as shown in FIG. 4B.

Then, the mold bearing the surface treated layer 32 is rinsed with a mixture of hexadecane and chloroform (in a weight ratio of 4:1) for 10 minutes in a dry atmosphere (including substantially no moisture), such as an atmosphere with a water vapor concentration of 0.006 kg/m³. Thus, an excessive portion of the compound (CF₃(CF₂)₈SiCl₃) adhered to the surface treated layer 32 is removed.

Subsequently, as shown in FIG. 4C, an organic film (for example, a resist film) 34 of a UV curing polysiloxane precursor with a thickness of 0.3 μm is formed on a substrate with a light transmitting property such as a quartz substrate 33. Then, as shown in FIG. 4D, the mold of FIG. 4B is brought close to the organic film 34.

Next, as shown in FIG. 5A, a pressing face of the reverse pattern 32 is pressed against the organic film 34 at a pressure of approximately 120 atm., so as to transfer the reverse pattern 32 onto the organic film 34. Thus, an organic film pattern (for example, a resist pattern) 34A is formed from the organic film 34.

Then, as shown in FIG. 5B, the organic film pattern 34A is irradiated with UV 35 through the quartz substrate 33 so as to cure the organic film pattern 34A. Then, the mold is moved away from the organic film pattern 34A. Thus, the fine organic film pattern 34A of, for example, 0.10 μm is formed on the quartz substrate 33 as shown in FIG. 5C.

In Embodiment 3, the organic film pattern 34A is formed by pressing, against the organic film 34, the reverse pattern 31 of the mold bearing the surface treated layer 32 including CF₃(CF₂)₈SiCl₃. Therefore, the reverse pattern 31 is smoothly moved away from the organic film pattern 34A, and the organic film pattern 34A is minimally adhered to the recess of the reverse pattern 31. Accordingly, the organic film pattern 34A is formed in a good shape as shown in FIG. 5C.

Furthermore, since the organic film pattern 34A is irradiated with the UV 35 through the quartz substrate 33 for curing the organic film pattern 34A, the organic film 34 can be made from a material with a softening property. As a result, the transfer of the reverse pattern 32 onto the organic film 34 can be eased.

Although the organic film 34 is made from a UV curing polysiloxane precursor in Embodiment 3, another UV curing resin can be used instead.

Also, in Embodiment 3, the organic film pattern 34A may be irradiated through the quartz substrate 33 with deep UV instead of the UV 35. Since such light can cure the UV curing organic film 34 in a short period of time, the throughput can be improved.

Although the compound included in the surface treated layer is CF₃(CF₂)₇(CH₂)₂SiCl₃ in Embodiment 1, CF₃(CH₂)₉Si(CH₃)Cl₂ in Embodiment 2 and CF₃(CF₂)₈SiCl₃ in Embodiment 3, the compound is not limited to them but may be widely selected from compounds represented by a general formula, CF₃(CZ)ₙSiXₐY₃₋ₐ, wherein n is an integer of 8 or more; a is 1, 2 or 3; Z are the same or different and selected from the group consisting of a hydrogen atom, a halogen atom, a substituted or non-substituted saturated or non-saturated alkyl group and a substituted or non-substituted aromatic group; X is a halogen atom; and Y is a hydrogen atom or a saturated alkyl group. Other examples of the compounds represented by the general formula are as follows:

(1) Example of compounds having a saturated substituted alkyl group as Z in the general formula:

CF₃(CHCF₃)₂(CH₂)₈SiCl₃, wherein a is 3 and X is Cl.

(2) Example of compounds having a saturated non-substituted alkyl group as Z in the general formula:

CF₃(C(CH₃)₂)CF₂(CH₂)₇SiH₂Cl, wherein a is 1, X is Cl and Y is H.

(3) Example of compounds having an unsaturated substituted alkyl group as Z in the general formula:

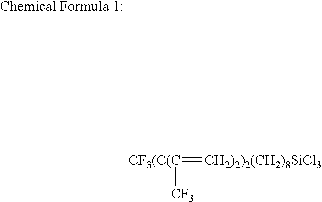

wherein a is 3 and X is Cl.

(4) Example of compounds having an unsaturated non-substituted alkyl group as Z in the general formula:

CF₃(CH(C=CH₂))(CF₂)₃(CH₂)₇SiHCl₂, wherein a is 2, X is Cl and Y is H.

(5) Example of compounds having a substituted aromatic group as Z in the general formula:

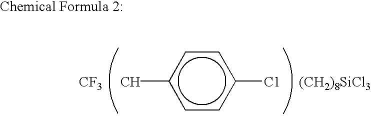

wherein a is 3 and X is Cl.

(6) Example of compounds having a non-substituted aromatic group as Z in the general formula:

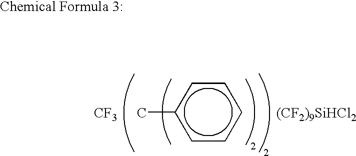

wherein a is 2, X is Cl and Y is H.

(7) Example of compounds having a hydrogen atom as Y in the general formula:

CF₃(CF₂)₇(CH₂)₂SiHCl₂, wherein a is 2 and X is Cl.

(8) Example of compounds having a saturated alkyl group as Y in the general formula:

CF₃(CF₂)₅(CH₂)₅Si(CH₃)₂Cl, wherein a is 1 and X is Cl.

Although X is a chlorine atom in the general formula of these compounds, another halogen atom such as a fluorine atom or a bromine atom may be used instead.

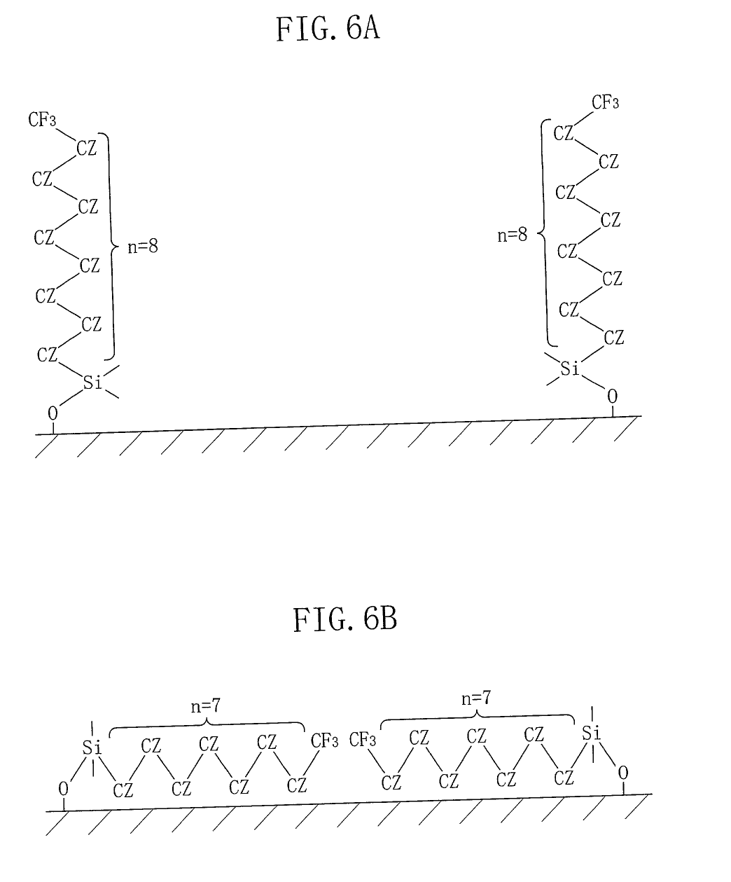

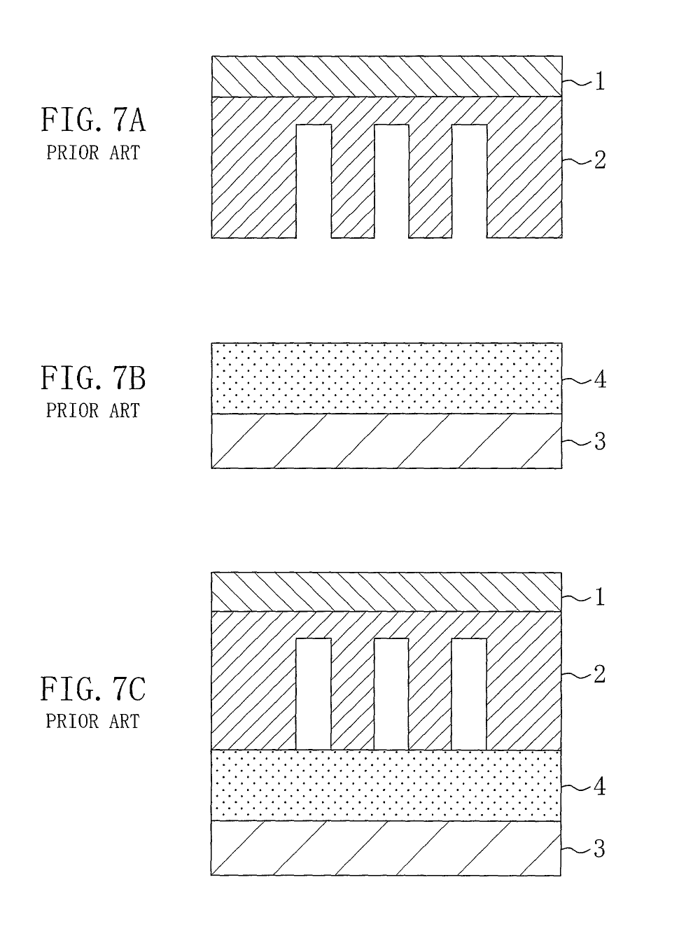

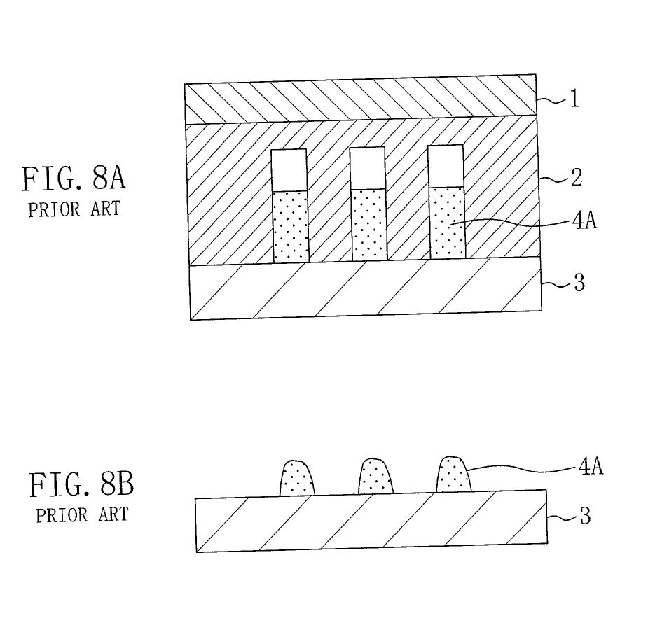

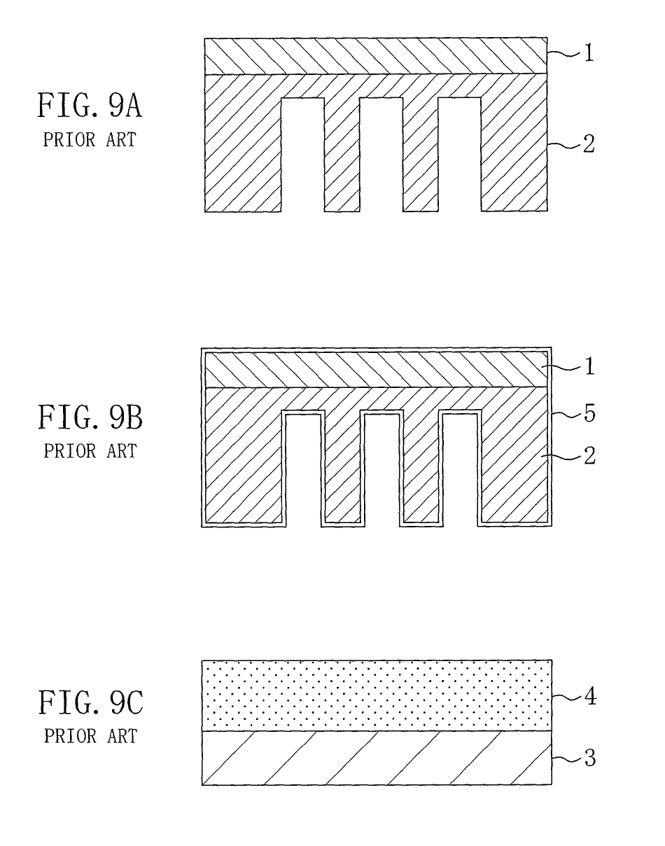

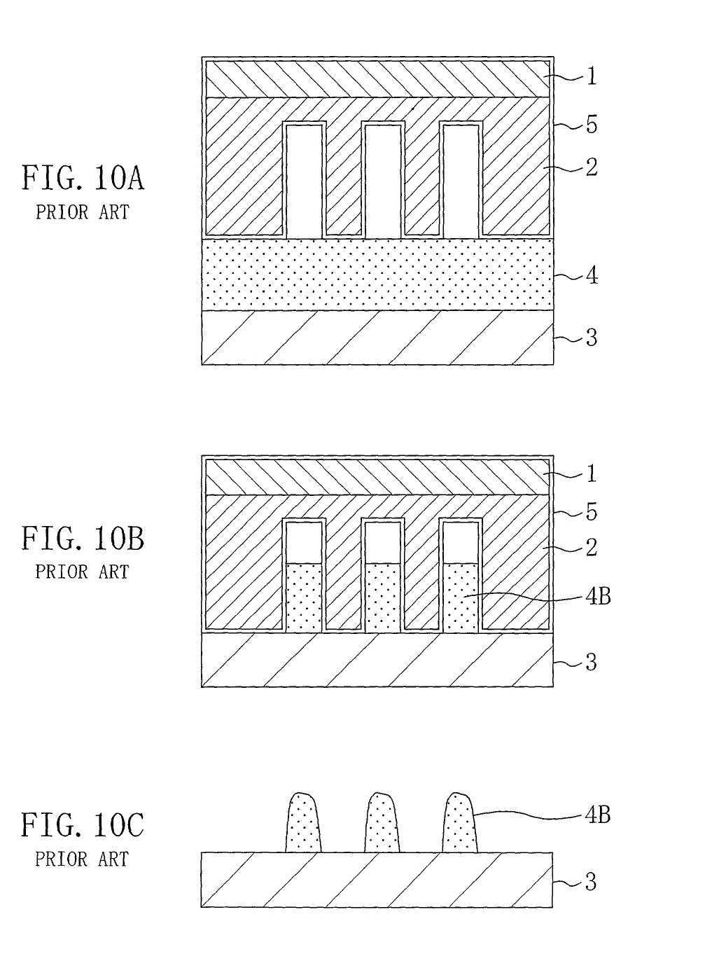

Now, the reason why a reverse pattern can be smoothly moved away from an organic film pattern substantially without adhering to the recess or projection of the reverse pattern when n is an integer of 8 or more in the general formula, CF₃(CZ)ₙSiXₐY₃₋ₐ, will be described with reference to FIGS. 6A and 6B.

FIG. 6A shows the structure of a surface treated layer obtained when n is 8 in the general formula, CF₃(CZ)ₙSiXₐY₃₋ₐ and FIG. 6B shows the structure of a surface treated layer obtained when n is 7 in the general formula, CF₃(CZ)ₙSiXₐY₃₋ₐ. In the general formula, XₐY₃₋ₐ bonded to Si does not have any technical meaning, and hence, XₐY₃₋ₐ is omitted in FIGS. 6A and 6B.

When n is 7, since the molecular chain of a monomolecular film of CF₃(CZ)ₙSi is short, the interaction between the adjacent molecular chains is small, and hence, the monomolecular films fall down as shown in FIG. 6B. In contrast, when n is an integer of 8 or more, since the molecular chain of the monomolecular film of CF₃(CZ)ₙSi is long, the interaction between the adjacent molecular chains is large, and hence, the monomolecular films are aligned without falling down as shown in FIG. 6A.

When the monomolecular films fall down as shown in FIG. 6B, CF₃ groups are difficult to be positioned in a surface portion of the surface treated layer. However, when the monomolecular films are aligned without falling down as shown in FIG. 6A, the CF₃ groups can be positioned in a surface portion of the surface treated layer.

Accordingly, the CF₃ groups can be aligned on the surface of the surface treated layer in this invention, namely, the surface treated layer is covered with the CF₃ groups, and therefore, the surface treated layer can be improved in its hydrophobic property.

Furthermore, since the monomolecular films are aligned without falling down in this invention, the surface treated layer can exhibit improved resistance in pressing the reverse pattern against the organic film.

The water vapor concentration is 0.006 kg/m³ in Embodiments 1 and 3 and is 0.005 kg/m³ in Embodiment 2, and the water vapor concentration is preferably 0.0076 kg/m³ or less in this invention. Thus, a good surface treated layer can be formed for the following reason: Since the compound represented by CF₃(CZ)ₙSiXₐY₃₋ₐ has a property to react with moisture, if a surface treated layer is formed in an atmosphere including moisture, the compound represented by CF₃(CZ)ₙSiXₐY₃₋ₐ reacts with the moisture, so that a good surface treated layer cannot be formed.

Although the surface treated layer is formed by immersing the mold body in the solution including the compound represented by CF₃(CZ)ₙSiXₐY₃₋ₐ in Embodiments 1 through 3, the surface treated layer may be formed by spin coating or rubbing for bringing the solution including the compound represented by CF₃(CZ)ₙSiXₐY₃₋ₐ into contact with the pressing face of the mold body. When the immersing is employed, however, the surface treated layer can be definitely formed with ease.

The solution including the compound preferably includes substantially no water for the following reason: When the solution includes water, the compound represented by CF₃(CZ)ₙSiXₐY₃₋ₐ reacts with water included in the solution, so that a good surface treated layer cannot be formed.

Although the organic film is a resist film in Embodiments 1 through 3, the organic film may be an insulating film formed on a semiconductor substrate such as an interlayer insulating film instead. When the organic film is an interlayer insulating film, an interconnect groove or a contact hole can be formed.

What is claimed is:

1. A mold comprising:
a mold body having a pressing face; and
a surface treated layer formed on at least said pressing face of said mold body and including a compound represented by a general formula, CF₃(CZ)ₙSiXₐY₃₋ₐ, wherein n is an integer of 8 or more; a is 1, 2 or 3; Z are the same or different and selected from the group consisting of a hydrogen atom, a halogen atom, a substituted or non-substituted saturated or unsaturated alkyl group and a substituted or non-substituted aromatic group; X is a halogen atom; and Y is a hydrogen atom or a saturated alkyl group.

2. The mold of claim 1,
wherein at least one of Z is a fluorine atom in said general formula.

3. The mold of claim 1,
wherein a projection or recess for forming a pattern is formed on said pressing face of said mold body.

4. A method for fabricating a mold comprising the steps of:
preparing a mold body having a pressing face; and
forming, at least on said pressing face of said mold body, a surface treated layer including a compound represented by a general formula, CF₃(CZ)ₙSiXₐY₃₋ₐ, by bringing said compound into contact with said pressing face, wherein n is an integer of 8 or more; a is 1, 2 or 3; Z are the same or different and selected from the group consisting of a hydrogen atom, a halogen atom, a substituted or non-substituted saturated or unsaturated alkyl group and a substituted or non-substituted aromatic group; X is a halogen atom; and Y is a hydrogen atom or a saturated alkyl group.

5. The method for fabricating a mold of claim 4, further comprising, after the step of forming a surface treated layer, a step of removing an excessive portion of said compound adhered to said mold body in an atmosphere including substantially no moisture.

6. The method for fabricating a mold of claim 5,
wherein a water vapor concentration in said atmosphere is 0.0076 kg/m³ or less.

7. The method for fabricating a mold of claim 4,
wherein at least one of Z is a fluorine atom in said general formula.

8. The method for fabricating a mold of claim 4,
wherein said compound is brought into contact with said pressing face by allowing a solution including said compound to come in contact with said pressing face.

9. The method for fabricating a mold of claim 8,
wherein said solution includes substantially no water.

10. The method for fabricating a mold of claim 8,
wherein said solution is allowed to come in contact with said pressing face by immersing, spin coating or rubbing.

11. The method for fabricating a mold of claim 4,
wherein the step of forming a surface treated layer is carried out in an atmosphere including substantially no moisture.

12. The method for fabricating a mold of claim 11,
wherein a water vapor concentration in said atmosphere is 0.0076 kg/m³ or less.

13. The method for fabricating a mold of claim 4,
wherein the step of preparing a mold body includes a sub-step of forming a projection or recess for forming a pattern on said pressing face.

14. A pattern formation method comprising the steps of:
forming an organic film on a substrate;
transferring a projection or recess for forming a pattern provided on a pressing face of a mold onto said organic film by pressing, against said organic film, said mold that has, at least on said pressing face, a surface treated layer including a compound represented by a general formula, CF₃(CZ)ₙSiXₐY₃₋ₐ, wherein n is an integer of 8 or more, a is 1, 2 or 3, Z are the same or different and selected from the group consisting of a hydrogen atom, a halogen atom, a substituted or non-substituted saturated or unsaturated alkyl group and a substituted or non-substituted aromatic group, X is a halogen atom, and Y is a hydrogen atom or a saturated alkyl group; and
moving said mold away from said organic film.

15. The pattern formation method of claim 14,
wherein at least one of Z is a fluorine atom in said general formula.

16. A pattern formation method comprising the steps of:
forming an organic film on a substrate with a light transmitting property;
transferring a projection or recess for forming a pattern provided on a pressing face of a mold onto said organic film by pressing, against said organic film, said mold that has, at least on said pressing face, a surface treated layer including a compound represented by a general formula, CF₃(CZ)ₙSiXₐY₃₋ₐ, wherein n is an integer of 8 or more, a is 1, 2 or 3, Z are the same or different and selected from the group consisting of a hydrogen atom, a halogen atom, a substituted or non-substituted saturated or unsaturated alkyl group and a substituted or non-substituted aromatic group, X is a halogen atom, and Y is a hydrogen atom or a saturated alkyl group;
curing said organic film by irradiating said organic film with light through said substrate; and
moving said mold away from said organic film.

17. The pattern formation method of claim 16,
wherein at least one of Z is a fluorine atom in said general formula.

18. The pattern formation method of claim 16,
wherein said light is UV or deep UV.
